(19) United States
(12) Patent Application Publication
(10) Pub. No.: US 2009/0282988 A1
(43) Pub. Date: Nov. 19, 2009

(54) ROTATING AND DRIVING DEVICE FOR BARBECUE

(76) Inventor: Ya-Ting CHEN, Shulin City (TW)

Correspondence Address: HDLS Patent & Trademark Services, P.O. BOX 220746, CHANTILLY, VA, 20153-0746, US

(21) Appl. No.: 12/119,621

(22) Filed: May 13, 2008

(51) Int. Cl. A47J 43/18

(52) U.S. Cl. 99/421 H

(57) ABSTRACT

A rotating and driving device for barbecue includes a casing, a fixing base, a driving means and a shielding plate. The casing has an upright plate and an enclosing plate. An accommodating space and an opening are formed between the upright plate and the enclosing plate. The fixing base is connected to the interior of the accommodating space. The driving means is fixed to the fixing base and located between the upright plate and the fixing base. The driving means has a rotary shaft penetrating the fixing base. The shielding plate is provided with a through hole to correspond to the rotary shaft. The shielding plate is connected to one side of the fixing base away from the driving means so as to cover the opening. Via the above arrangement, electrical elements in the casing can be protected, and the leakage of electricity caused by the penetration of moisture can be efficiently prevented.

### BACKGROUND OF THE INVENTION

1. Field of the Invention

The present invention relates to a driving device, and in particular to a rotating and driving device for barbecue.

2. Description of Prior Art

In the circumstances of high pressure and the demand for excellent working performance, many people like to do some activities in their leisure time to energize themselves and relieve the pressure. For example, barbecue is a popular leisure activity. During a barbecue, charcoal is used as fuel. Since the burning of charcoal needs a large amount of oxygen and the insufficient amount of oxygen in a house may be harmful to health, the barbecue is often made outdoors.

Further, during a barbecue, if a rotating and driving device is used to turn the foods automatically and thus the foods can be heated uniformly, not only the taste of the foods can be increased, but also burden of the person who is grilling can be reduced. Further the person who is grilling can be avoided from inhaling bad gases (such as carbon dioxide) to harm his body.

When the rotating and driving device is applied to a grill, the penetration of moisture into electrical elements inside the grill, the leakage of electricity, the ventilation and heat dissipation should be taken into consideration. Therefore, the present invention is made in order to overcome the above-mentioned concerns.

### SUMMARY OF THE INVENTION

The present invention is to provide a rotating and driving device for barbecue, in which a fixing base is disposed in an accommodating space of the casing, and a shielding plate is covered outside the fixing base. Via this arrangement, electrical elements within the casing can be protected, and the leakage of electricity caused by the penetration of moisture can be prevented efficiently.

The present invention provides a rotating and driving device for barbecue, which includes a casing, a fixing base, a driving means and a shielding plate. The casing has an upright plate and an enclosing plate extending from the periphery of the upright plate. An accommodating space is formed between the upright plate and the enclosing plate. An opening is formed on the periphery of the enclosing plate. The fixing base is connected to the casing and is accommodated in the accommodating space. The driving means is fixed to the fixing base and located between the upright plate and the fixing base. The driving means comprises a rotary shaft penetrating the fixing base. The shielding plate is provided with a through hole to correspond to the rotary shaft. The shielding plate is connected to one side of the fixing base away from the driving means so as to cover the opening.

The present invention is to provide an outdoor rotating and driving device for barbecue, in which a channel is formed between the shielding plate and the casing, through which hot air within the casing can be dissipated, and the internal moisture can be guided to the outside.

### BRIEF DESCRIPTION OF THE DRAWINGS

FIG. 1 is an exploded perspective view showing the rotating and driving device of the present invention;

FIG. 2 is an exploded perspective view showing the shielding plate of the present invention not being connected to a fixing base;

FIG. 3 is an assembled view showing the rotating and driving device of the present invention;

FIG. 4 is a cross-sectional view taken along the line 4-4 of FIG. 3; and

FIG. 5 is an assembled view showing the rotating and driving device of the present invention being applied to a grill.

### DETAILED DESCRIPTION OF THE INVENTION

The detailed description and technical contents of the present invention will be made with reference to the accompanying drawings. However, the drawings are illustrative only, but not used to limit the present invention.

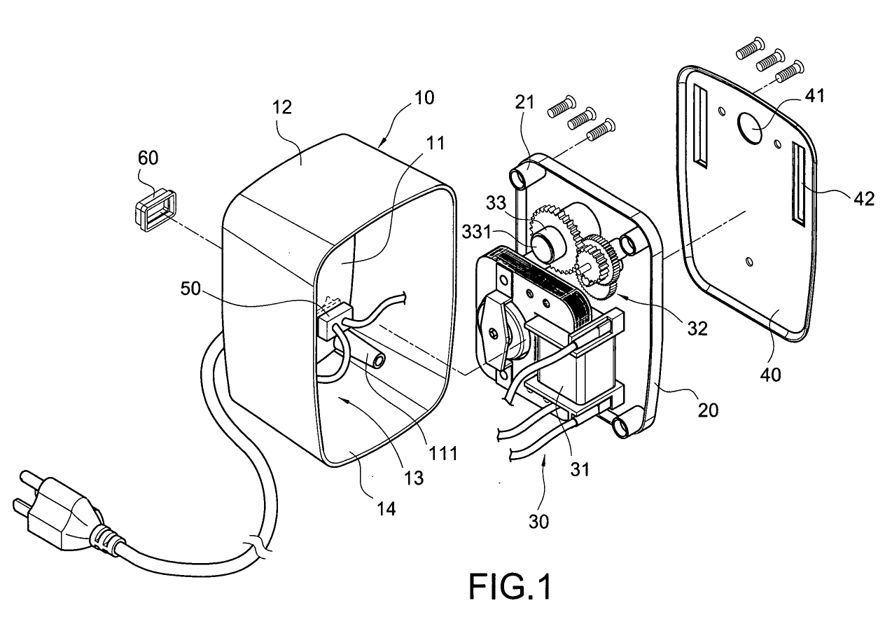

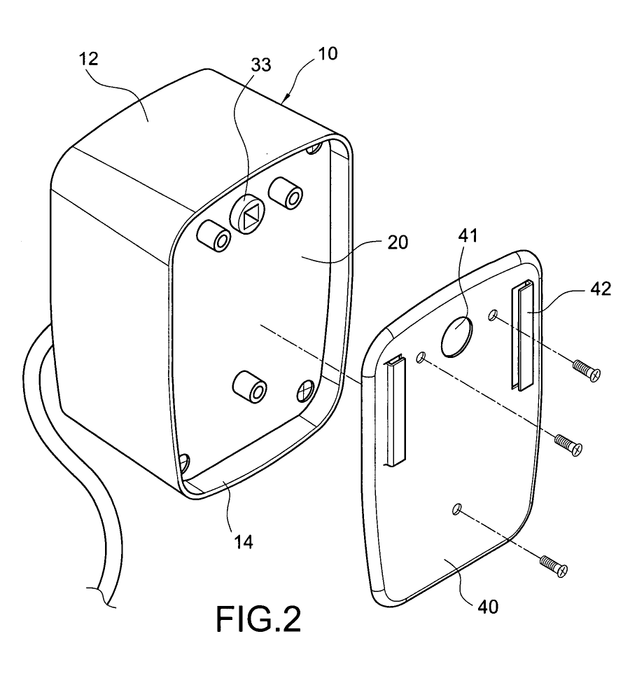

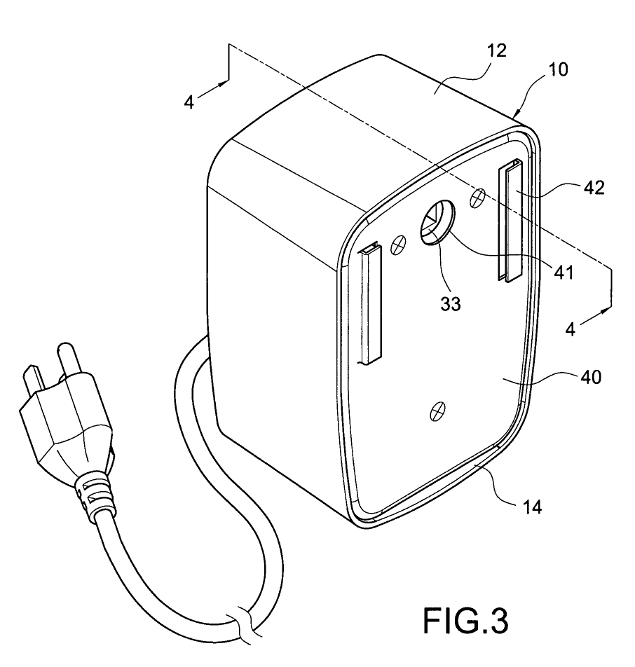

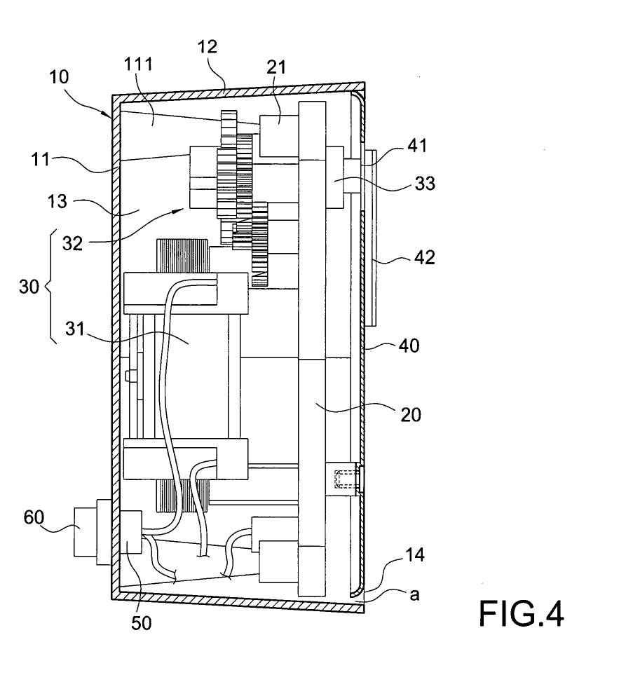

Please refer to FIGS. 1 to 4. FIG. 1 is an exploded perspective view showing the rotating and driving device of the present invention, FIG. 2 is an exploded perspective view showing the shielding plate of the present invention not being connected to a fixing base, FIG. 3 is an assembled view showing the rotating and driving device of the present invention, and FIG. 4 is a cross-sectional view taken along the line 4-4 of FIG. 3. The present invention provides an outdoor rotating and driving device for barbecue, which includes a casing 10, a fixing base 20, a driving means 30 and a shielding plate 40.

The casing 10 is made of anti-UV plastic materials and has a rectangular upright plate 11. The upright plate 11 is provided thereon with a through hole (not shown) for connecting to a switch 50. Four corners of the upright plate 11 are provided with a cylindrical post respectively. A quadrangular enclosing plate 12 extends from the periphery of the upright plate 11. An accommodating space 13 is formed between the upright plate 11 and the enclosing plate 12. An opening 14 is formed on the outer periphery of the enclosing plate 12. The upper and lower sides of the enclosing plate 12 expand outwards and obliquely toward the opening 14.

The fixing base 20 is formed into a rectangular body. Four corners of the fixing base 20 extend to form positioning sleeves 21 to correspond to the cylindrical posts 112 respectively. With the positioning sleeves 21 being connected to the cylindrical posts 112 and locked by screw elements, the fixing base 20 can be received in the accommodating space 13.

The driving means 30 comprises a motor 31, a reduction gear assembly 32 and a rotary shaft 33. The motor 31 is electrically connected to the switch 50. The motor 31 and the reduction gear assembly 32 are fixed on the fixing base 20 and located between the upright plate 11 and the fixing base 20. The rotary shaft 33 penetrates the fixing base 20. The motor 31 drives the reduction gear assembly 32 first, and then the reduction gear assembly 32 drives the rotary shaft 33 to rotate. The rotary shaft 33 is a hollow shaft. One side of the rotary shaft is formed with a gear operatively engaged with the reduction gear assembly 32. An end of the rotary shaft is sealed by a cap 331 (FIG. 1), thereby preventing the external moisture from penetrating into the casing 10.

The shielding plate 40 is provided with a through hole 41 to correspond to the rotary shaft 33, and is connected to the one side of the fixing base 20 away from the driving means 30 via screw elements so as to cover the opening 14. A channel a is formed between the lower edge of the shielding plate 40 and the enclosing plate 12, through which the internal hot air can be dissipated and the internal moisture and can be guided to the outside. An insertion piece 42 is formed on both sides of the through hole 41 by means of punching.

Further, the present invention includes a waterproof sheath 60 that covers the outside of the switch 50 to prevent the penetration of moisture and the leakage of electricity.

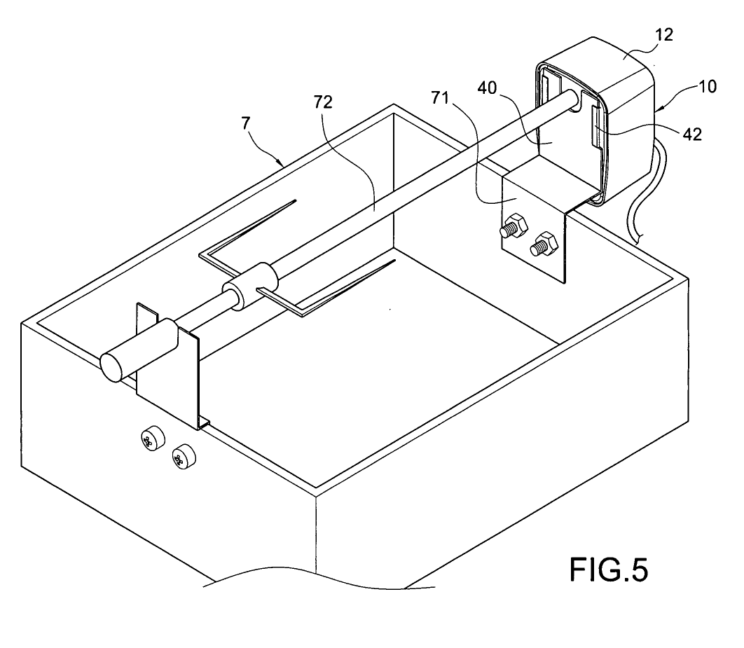

Please refer to FIG. 5, which is an assembled view showing the rotating and driving device of the present invention being applied to a grill. The rotating and driving device of the present invention can be applied to a grill 7. The grill 7 is fixedly connected with an angled plate 71. The insertion piece 42 is connected to the angled plate 71. A rod 22 penetrates through the rotating shaft 33. When the switch 50 is turned on, the reduction gear assembly 32 can drive the rotating shaft 33 and in turn the rod 72 via the action of the motor 31, so that the foods (not shown) on the rod 72 can be grilled uniformly.

According to the above, the present invention really achieves has industrial applicability, novelty and inventive steps. Further, the structure of the present invention has not been published or used in public, and thus it conforms to the requirements for a utility model patent.

What is claimed is:

1. A rotating and driving device for barbecue, comprising:
a casing having an upright plate and an enclosing plate extending from the periphery of the upright plate, an accommodating space being formed between the upright plate and the enclosing plate, an opening being formed on the periphery of the enclosing plate;
a fixing base connected to the casing and accommodated in the accommodating space;
a driving means fixed to the fixing base and located between the upright plate and the fixing base, the driving means comprising a rotary shaft penetrating the fixing base; and
a shielding plate provided with a through hole to correspond to the rotary shaft, the shielding plate being connected to one side of the fixing base away from the driving means so as to cover the opening.

2. The rotating and driving device for barbecue according to claim 1, wherein each corner of the upright plate extends to form a cylindrical post respectively, a plurality of positioning sleeves are formed on the fixing base to correspond to the cylindrical posits, the cylindrical posits and the positioning sleeves are locked to each other via screw elements.

3. The rotating and driving device for barbecue according to claim 1, wherein the lower edge of the enclosing plate is inclined toward the opening, a channel is formed between the lower edge of the shielding plate and the enclosing plate.

4. The rotating and driving device for barbecue according to claim 1, wherein the rotary shaft is a hollow shaft with one end thereof sealed by a cap.

5. The rotating and driving device for barbecue according to claim 1, wherein the driving means further comprises a motor and a reduction gear assembly, the motor and the reduction gear assembly are fixed on the fixing base respectively, the motor drives the reduction gear assembly, and the reduction motor assembly drives the rotary shaft to rotate.

6. The rotating and driving device for barbecue according to claim 5, further comprising a switch fixed on the upright plate and electrically connected with the motor.

7. The rotating and driving device for barbecue according to claim 6, further comprising a waterproof sheath for covering the outside of the switch.
